(19) United States
(12) Patent Application Publication
(10) Pub. No.: US 2004/0255303 A1
(43) Pub. Date: Dec. 16, 2004

(54) State machine programming language, a method of computer programming and a data processing system implementing the same

(76) Inventors: Timothy James Hogan, Wellington (NZ); Paul Leslie Carter, Wellington (NZ); Joshua Elliott, Wellington (NZ)

Correspondence Address: Mark T Starr, Unisys Corporation, Unisys Way M S E8 114, Blue Bell, PA, 19424-0001, US

(21) Appl. No.: 10/493,086

(22) PCT Filed: Oct. 19, 2001
(86) PCT No.: PCT/NZ01/00232

(51) Int. Cl. G06F 9/46; G06G 7/62

(52) U.S. Cl. 719/318; 703/13

(57) ABSTRACT

A state machine language having a syntax requiring each state to be uniquely named and having associated state definition information including:

i) the definition of each action to be executed upon transition to that state; and

ii) the definition of each event which will cause transition to another state and the name of the next state to which operation will progress.

### FIELD OF THE INVENTION

The present invention relates to a state machine programming language and its implementation. The state machine programming language of the invention enables direct programming in the state machine language to implement a state machine.

### BACKGROUND TO THE INVENTION

A state machine specifies the sequences of states that an object or an interaction goes through during its lifetime in response to events, together with its responses to those events. State machine models are particularly suited for modelling certain systems, such as automated voice-prompting telephone answering systems, traffic light systems, electronic circuits etc.

Currently available computer languages are generally purely procedurally based (eg. C/C++, Pascal, Java, Basic). To implement a state tree definition a programmer must create a state machine that executes the states. This can be time consuming utilising currently available computer languages and the solution may not be reusable.

Certain applications have been developed for creating state machines but they are generally limited to particular applications and/or complex and/or time consuming to implement.

U.S. Pat. No. 5,485,600 discloses a visual modelling system for defining relationships between objects. The relationships may be defined utilising a state table. A user is required to set up the environment for each state table, edit the state table for the particular application and then generate a program utilising information from the state table. The state table is utilised as a tool to generate a program utilising a pre-existing language. There is no suggestion that programming may be effected directly via a state machine programming language. The programming method disclosed in this patent is time consuming and laborious to implement and does not facilitate the reuse of programming code.

### SUMMARY OF THE INVENTION

It is an object of the present invention to provide a state machine programming language that allows a programmer to program directly according to a state machine model that clearly defines the structure of a state machine or to at least provide the public with a useful choice.

According to a first aspect of the invention there is provided a method of computer programming utilising a state machine programming language including the steps of:

defining a plurality of states according to the syntax of the state machine programming language, each state having state definition information including:

i. a definition of each action to be executed upon transition to that state; and

ii. a definition of each event which will cause transition to another state and the name of the next state to which operation will progress;

wherein functions called by actions are defined separately from the state definitions.

According to a further aspect there is provided a data processing system including:

a storage device containing state information according to the syntax of a state machine programming language including:

definitions for a plurality of states in which each state definition includes:

i. a definition of each action to be executed upon transition to that state; and

ii. a definition of each event which will cause transition to another state and the next state to which operation will progress; and

iii. a processor which executes the actions in accordance with the state information for the current state and effects state transitions in response to event information;

wherein functions called by actions are defined separately from the state definitions.

According to a further aspect there is provided a computer programmed to operate according to a state based programming language wherein to create a program the computer requires a user to enter state information according to a required syntax for each state including:

i. a state name;

ii. actions to be executed upon transition to the state; and

iii. each event which will cause transition to another state and the name of the next state;

wherein functions called by actions are defined separately from the state information.

### BRIEF DESCRIPTION OF THE DRAWINGS

The invention will now be described by way of example with reference to the accompanying drawings in which:

FIG. 1: shows a simple state machine.

FIG. 2: shows a computer system suitable for executing the state machine programming language of the invention.

FIG. 3: shows a state machine for implementing an automated voice-prompting telephone answering system.

### DETAILED DESCRIPTION OF THE BEST MODE FOR CARRYING OUT THE INVENTION

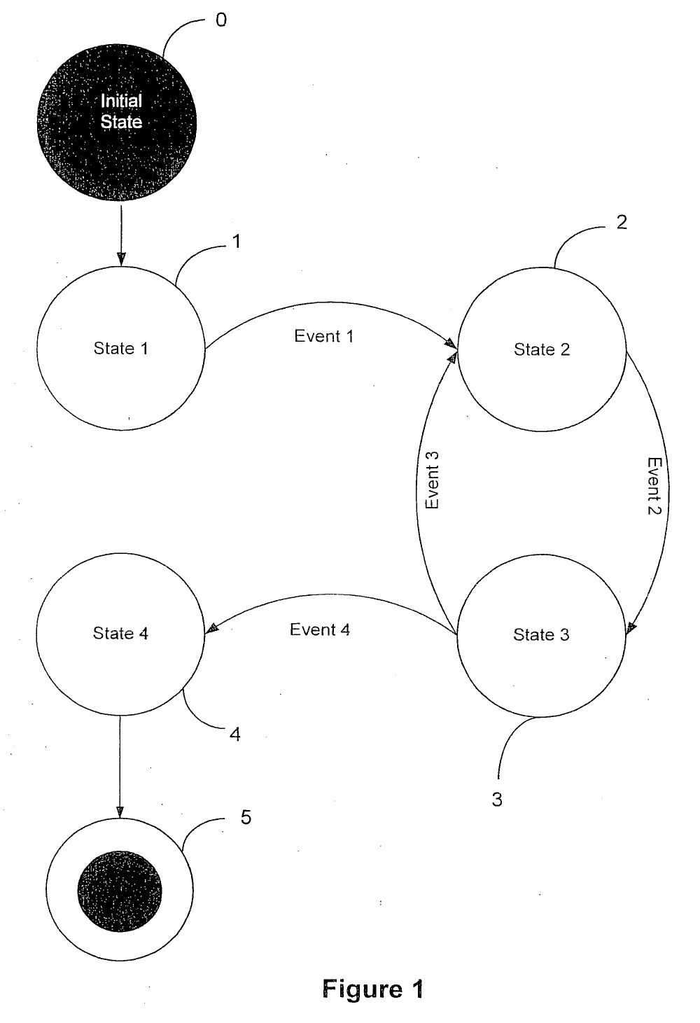

Referring to FIG. 1 a graphical representation of a state machine is shown. From an initial State 0 operation may progress to a first State 1. Whilst in State 1 certain actions may be executed. Upon the occurrence of an Event 1 operation may progress to State 2 where another set of actions may be performed. Upon the occurrence of Event 2 operation may proceed to State 3 where a further set of actions may be executed. Upon the occurrence of Event 3 operation may return to State 2 or, upon occurrence of Event 4 operation may proceed to State 4 where a further set of actions may be executed. Operation may then terminate at a final State 5.

Although state models have been used to model sequential processes, state diagrams and tables have merely been utilised as a tool to develop a resulting program.

According to the present invention a state machine language has been developed whereby a programmer may structure a program in the state machine language in a manner reflecting the logical operation within a state machine diagram.

According to the invention a machine based programming language is provided which separates state definitions from procedural code and treats the procedural code as an adjunct to the main state handling code. This allows a programmer to clearly define the structure of a state machine and simplifies the writing and maintaining of programs to implement state machines.

According to the state machine language of the invention each state is given an unique state name by the programmer; the actions to be executed whilst the program is in that state are defined; and the events causing the program to progress to a new state along with the new state are also defined. The format for defining each state is as below:

State Name

actions

Function call 1

Function call 2

Function call n

events

event 1: next state 1

event 2: next state 2

event n: next state n

end

One or more action may be defined for each state. A number of states may execute the same action. One or more event may trigger a transition to a new state. Different events may trigger transitions to different states.

Each state is preferably defined within a block of code. Each state definition is preferably separated from each other state definition by a blank line.

The actions defined within each state definition may be common functions which may be defined within a “function” definition. This may be conveniently provided at the end of the state definitions.

The events that may trigger a state transition may be inputs from input devices, the outputs of function calls etc. Any function may execute any other function which will, when executed, return to the calling parent function. A function is represented by its name, its interface and a set of instructions defining the functions operation as follows:

Function name

Interface

Instructions defining the function's operation

Within a state machine it may be desirable to identify a portion of the state tree as a sub-branch. When operation proceeds to the sub-branch, operation may proceed according to the sub-branch state definition until operation proceeds to the final state of the sub-branch, whereupon operation then returns to the parent state tree definition. This approach may be applied to any sub-branch depth. Accordingly, for example, the state diagram shown in FIG. 1 may represent a sub branch of a larger state diagram. The section of definitions for states 1-4 may be identified as a sub-branch. Such a sub-branch may be called as an action for a state of the parent state tree definition. This may enable commonly used sub-branches to be defined once and to be used by any parent state. This allows state definitions to be compact, simple, easy to understand and better structured. This approach is analogous to a parent function calling another child function that returns back to the calling parent when it is finished.

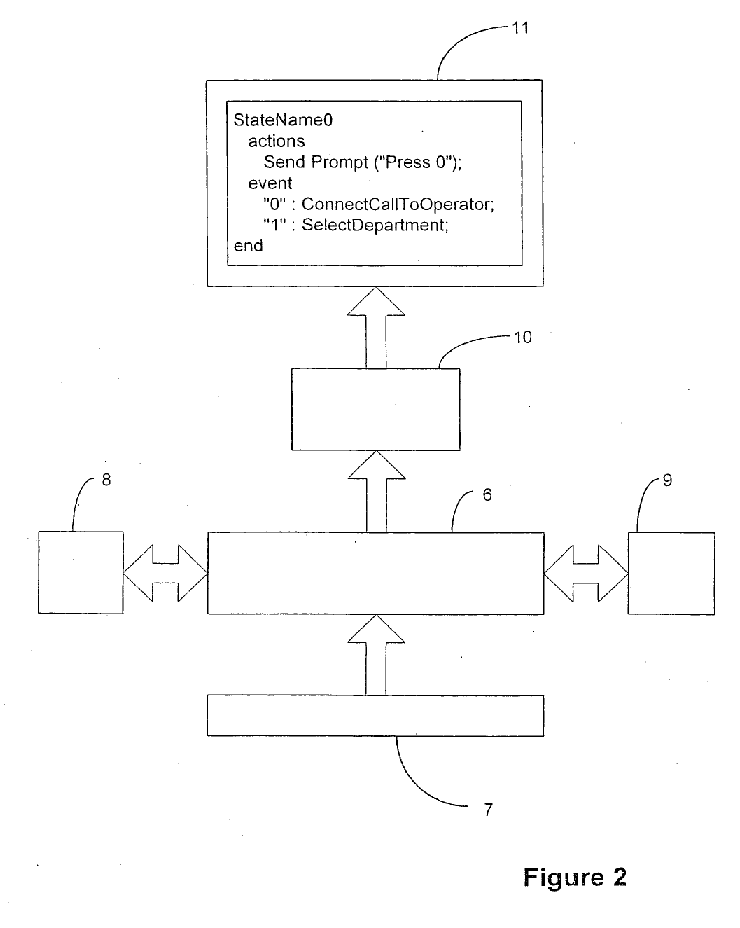

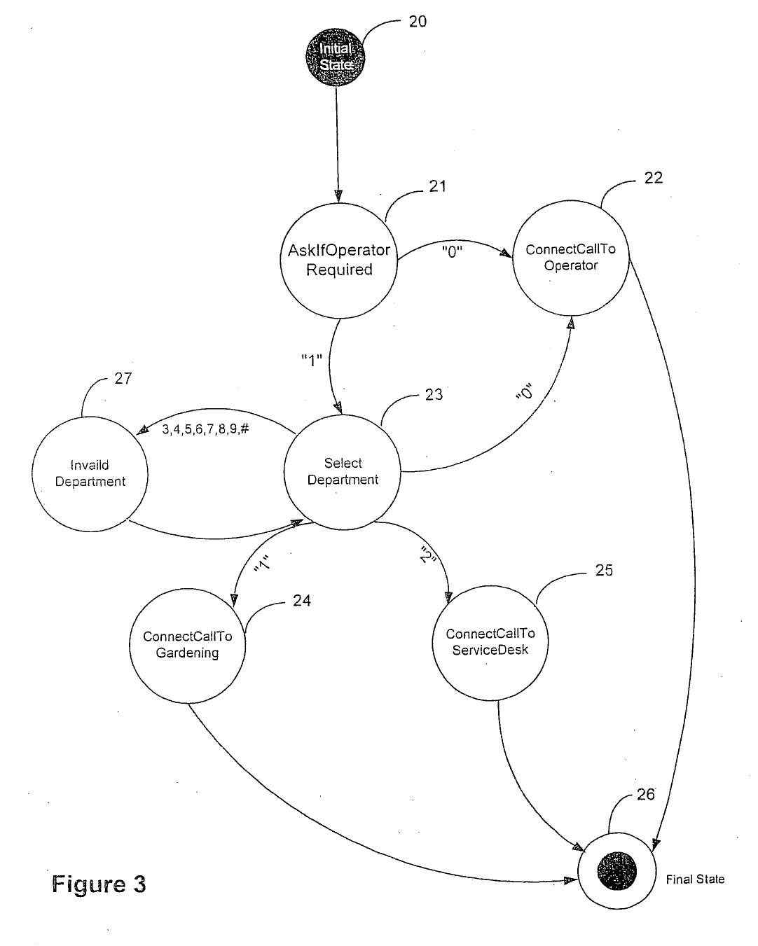

Referring now to FIGS. 2 and 3 a computer for implementing the state machine language of the invention is described in conjunction with an automated voice prompting telephone answering system application by way of example only.

Referring to FIG. 2 the computer may be of standard architecture including a microprocessor 6 which receives input from an input device 7 such as a keyboard. RAM 8 provides temporary data storage and hard disk drive 9 provides permanent storage. An operating system and the state machine language program may be stored on hard disk 9 and loaded into RAM during operation. Processor 6 outputs graphics information to graphics driver 10 which drives display 11. Typically a user will type in a code which will be displayed by display 11, stored on hard disk drive 9 and executed by processor 6.

FIG. 3 illustrates a state machine diagram for a telephone voice prompting system for accessing departments of a business. From Initial State 20 operation proceeds to state 21 where a caller is asked whether operator assistance is required. If “0” is pressed operation proceeds to State 22 and the call is connected to an operator. If a “1” is pushed operation proceeds to State 23. If “1” is selected the call is connected to gardening in State 24. If key “2” is selected operation proceeds to step 25 and the call is connected to the service desk. Once the required functions are executed in states 22, 24 and 25 operation proceeds to final state 26. If any invalid key is selected in State 23 operation proceeds to step 27 and returns to State 23.

The following is a possible implementation of such a system utilising the state machine language of the invention:

```
// The first state is always the start state for the machine
State AskIfOperatorRequired
                actions
                        SendPrompt (“Press 0 to contact an operator
                        or 1 for a list of departments”);
                event
                “0” : ConnectCallToOperator;
                “1” : SelectDepartment;
end
State ConnectCallToOperator
                actions
                        SendMessage (“Connecting to the operator”);
                        ConnectCall ( Operator );
                event
                        default: FINAL_STATE;
end
State SelectDepartment
                actions
                        SendPrompt (“Please select the number of
                the department you are interested in or * to talk to the
                operator”);
                event
                        ‘1’ : ConnectCallToGardening;
                        ‘2’: ConnectCallToServiceDesk;
                        ‘*’: ConnectCallToOperator;
                        default: InvalidDepartment;
end
State ConnectCallToGardening
                actions
                        SendMessage (“Connecting to the Gardening
department”);
                        ConnectCall ( Gardening);
                event
                        default: FINAL_STATE;
end
State ConnectCallToServiceDesk
                actions
                        SendMessage (“Connecting to the Service
                        Desk”);
                        ConnectCall (ServiceDesk);
                event
                        default: FINAL_STATE;
end
State InvalidDepartment
                actions
                        SendMessage (“Sorry, no such department
number”);
                        Desk”);
                event
                        default: SelectDepartment;
end
FUNCTIONS
        function ConnectCall (department)
        {
                ExtensionNumber = lookup (department);
                RouteVoiceCall (ExtensionNumber);
        }
        function SendPrompt (prompt)
        {
                VoiceCotent = ConvertToVoice (prompt);
                SendVoice (VoiceContent);
                Key = GetUserResponse( );
                Return key;
        }
        function SendMessage (message)
        {
                VoiceContent = ConvertToVoice (message);
                SendVoice (Voice Content);
        }
```

In this example the first state “AskIfOperatorRequired” is the initial state. The action definition for this state includes the “SendPrompt” function. This function is defined at the end of the programme definition which instructs the content to be converted to voice. The bracketed content “press “0” to contact an operator or “1” for a list of departments” will thus be sent as a voice message to the caller. In the event definition the event of pressing key “0” results in a transition to state ConnectCallToOperator and pressing “1” results in a transition to the state SelectDepartment. The other state definitions are likewise defined by their names, actions and the events (each event having an associated next state).

The functions are defined by their name (eg. “ConnectCall”), interface (eg. Department) and instructions (eg. ExtensionNumber=lookup (department); RouteVoiceCall (ExtensionNumber).

By way of comparison the following code is an example of an implementation of the state machine diagram of FIG. 3 written in a procedural programming language.

```
program VoicePrompter ( )
begin
        currentState = AskIfOperatorRequired
        While currentState != FINAL_STATE do
        begin
                key = GetUserKey( )
                select CurrentState of
                        case AskIfOperatorRequired :
                        {
                                key = SendPrompt (“Press 0
        to contact an operator or 1 for a list of departments”):
                        if key = ‘0’ then
                                CurrentState =
        ConnectCallToOperator;
                        Else
                                CurrentState =
        SelectDepartment;
                        }
                        case ConnectCallToOperator:
                        {
                                SendMessage (“Connecting to the
operator”);
                                CurrentState = FINAL_STATE;
                                ConnectCall ( Operator )
                        }
                        case SelectDepartment:
                        }
                                Key = Sendprompt (“Please select
        the number of the department you are interested in or * to talk to
        the operator”);
                                If key = ‘1’ then
                                CurrentState =
        ConnectCallToGardening;
                        Else
                        If key = ‘2’ then
                                CurrentState =
        ConnectCallToServiceDesk;
                        Else
                        If key = ‘*’ then
                                CurrentState =
        ConnectCallToOperator;
                        Else
                                CurrentState =
        Invalid Department;
                        }
                        case ConnectCallToGardening:
                        {
                                SendMessage (“Connecting to the
Gardening department”);
                                CurrentState = FINAL_STATE;
                                ConnectCall ( Gardening );
                        }
                        case ConnectCallToServiceDesk:
                        }
                                SendMessage (“Connecting to the
Service Desk”);
                                CurrentState = FINAL_STATE;
                                ConnectCall (ServiceDesk);
                        }
                        case InvalidDepartment:
                        {
                                SendMessage (“Sorry, no such
department number”);
                                CurrentState =
        SelectDepartment;
                        }
                end case
          end while
        end program
        function ConnectCall (department)
        {
                ExtensionNumber = lookup (department);
                RouteVoiceCall (ExtentionNumber);
        }
        function SendPrompt (prompt)
        {
                VoiceContent = ConvertToVoice (prompt);
                SendVoice (VoiceContent);
                Key = GetUserResponser ( );
                Return (key);
        }
        function SendMessage (message)
        {
                VoiceConent = ConvertToVoice (message);
                Send Voice (VoiceContent);
        }
```

It will be noted that the state information is buried amongst procedural control statements and the states, actions and transitions of the state machines are difficult to discern.

It will thus be seen that the invention provides a state machine language which allows a programmer to clearly define the structure of a state machine, and thus facilitate the writing and maintaining of programs implementing state machines. The syntax of the state machine language of the invention allows states and transitions to be explicitly defined, making the state machine structure readily discernible. This greatly simplifies writing and maintaining programs written in the state machine language of the invention.

1. A method of computer programming utilizing a state machine programming language including the steps of:
defining a plurality of states according to the syntax of the state machine programming language, each state having state definition information including:
i) a definition of each action to be executed upon transition to that state; and
ii) a definition of each event which will cause transition to another state and the name of the next state to which operation will progress;
wherein functions called by actions are defined separately from the state definitions.

2. A method as claimed in claim 1 wherein each state name, its associated actions and events are grouped together.

3. A method as claimed in claim 1 wherein the functions are defined following the state definitions.

4. A method as claimed claim 1 wherein multiple actions are executed upon transition to a state.

5. A method as claimed in claim 1 wherein an action is executed by a plurality of states.

6. A method as claimed in claim 1 wherein at least two events are defined for a state, each causing a transition to a different state.

7. A method as claimed in claim 1 wherein a state transition is contingent upon multiple events.

8. A method as claimed in claim 1 wherein one or more state includes one or more sub states.

9. A method as claimed in claim 8 wherein the sub states are defined.

10. A method as claimed in claim 1 wherein an event is a default event, being any or no action.

11. A method as claimed in claim 1 wherein the state definitions are entered via a user input device of a computer.

12. A method as claimed in claim 1 wherein the state definitions are stored in computer readable media.

13. A computer program produced according to the method of claim 1.

14. A computer readable medium embodying a computer program as claimed in claim 13 operable to cause a computer to exercise said method when said computer program from said medium is loaded and operating in said computer.

15. A computer programmed to operate according to the computer program of claim 13.

16. A data processing system including:
a storage device containing state information according to the syntax of a state machine programming language including:
definitions for a plurality of states in which each state definition includes:
i) a definition of each action to be executed upon transition to that state; and
ii) a definition of each event which will cause transition to another state and the next state to which operation will progress; and
iii) a processor which executes the actions in accordance with the state information for the current state and effects state transitions in response to event information;
wherein functions called by actions are defined separately from the state definitions.

17. (Cancelled)

18. A system as claimed in claim 16 wherein the event information is input data.

19. A system as claimed in claim 16 wherein the event information is the output of one or more actions.

20. A system as claimed in 16 wherein the system is an automated voice-prompting telephone answering system.

21. A computer programmed to operate according to a state based programming language wherein to create a program the computer requires a user to enter state information according to a required syntax for each state including:
i) a state name;
ii) actions to be executed upon transition to the state; and
iii) each event which will cause transition to another state and the name of the next state;
wherein functions called by actions are defined separately from the state information.

22. A computer as claimed in claim 21 including a display device which displays state information for each state within a display sub region.

23. A computer as claimed in claim 22 wherein the state information for each state is displayed as a separate block of text.

24. A computer as claimed in claim 22 wherein functions called by actions are displayed in a separate function block.

25. A computer as claimed in claim 20 which executes the defined actions for a state upon transition to that state and effects transition to a next state upon the occurrence of a specified event.

26. A computer as claimed in claim 25 wherein the computer executes the actions by calling functions from the function block.

27. A computer as claimed in claim 22 wherein functions called by actions are displayed in a separate function block.
